(19) United States
(12) Patent Application Publication
(10) Pub. No.: US 2008/0008863 A1
(43) Pub. Date: Jan. 10, 2008

(54) Laminated Offset Glazing

(76) Inventor: Philippe Van Damme, Nodrenge (BE)

Correspondence Address: BRENC LAW;ANDREW BRENC, P.O. BOX 155, ALBION, PA, 16401-0155, US

(21) Appl. No.: 11/428,578

(22) Filed: Jul. 5, 2006

(51) Int. Cl. B32B 23/02

(52) U.S. Cl. 428/192

(57) ABSTRACT

It has now been surprisingly discovered, according to the present invention, that the use of a laminated glazing panel in an offset glazing for use as a protective side window in vehicles results in a glazing that has improved resistance to breakage and removal after repeated impacts.

### FIELD OF THE INVENTION

The present invention is in the field of special application glazings that are used in vehicles, and, specifically, the present invention is in the field of automobile side window glazings that incorporate an offset glazing for added window strength.

### BACKGROUND

Automobile safety glass for side windows has, conventionally, been formed from a single pane of tempered glass having a thickness of, for example, 4 millimeters. While this glass is usually suitable for use in general purpose passenger vehicles, it presents what is commonly considered the easiest point of entry for thieves, and offers little or no protection against physical impacts on the glass; indeed, by its very nature heat strengthened glass is designed to shatter into many small pieces if a great enough impact is delivered to the glass, which results in the removal of virtually all of the original glass from the window opening.

In order to provide more impact resistance to side vehicle glass, and particularly for the purpose of providing protection against the penetration of bullets through the glass, “offset” glass has been employed in place of standard, single-pane tempered glass. Offset glass incorporates a second pane of glass or other rigid material inboard of the usual first pane. The offset pane is sized so that one edge is recessed from the matching edge of the first pane so that the offset glass can be incorporated into existing vehicles with few or no changes.

In typical bullet proof embodiments, the offset pane of glass consists of a very thick pane of tempered glass or a polycarbonate plastic. In either case, the offset pane, in combination with the first pane, functions to prevent the passage of a bullet into the vehicle in the event that a bullet strikes the first pane.

These offset glazing bullet proof constructs, while functioning well in their intended capacity to stop bullets, do not function well to stop the removal of the window through blows from an object such as might occur during a break-in attempt. Once again the tempered glass has a tendency to break and fragment after a large impact, which can cause the entire offset glass structure to break free from the window opening.

Accordingly, further improved offset windows for use as a comprehensive protective window in vehicle window applications is needed in the art.

### SUMMARY OF THE INVENTION

It has now been surprisingly discovered, according to the present invention, that the use of a laminated glazing panel in an offset glazing for use as a protective side window in vehicles results in a glazing that has improved resistance to breakage and removal after repeated impacts.

### BRIEF DESCRIPTION OF THE DRAWINGS

FIG. 1 represents a schematic overhead cross sectional view of a conventional side vehicle window employing a single pane of tempered glass.

FIG. 2 represents a schematic overhead cross sectional view of a conventional bullet proof side vehicle window employing an offset glazing.

FIG. 3 represents a schematic overhead cross sectional view of an offset glazing of the present invention.

FIG. 4 represents a schematic overhead cross sectional view of a an offset glazing of the present invention.

### DETAILED DESCRIPTION

The present invention is directed to vehicle windows that incorporate a laminated glass panel in an offset glazing to provide superior breakage resistance. Windows of the present invention are well suited for use in retractable windows, and can also be used in fixed windows, with both applications providing the same benefit of allowing the use of offset windows of the present invention without the need to modify or significantly modify existing window frame structures.

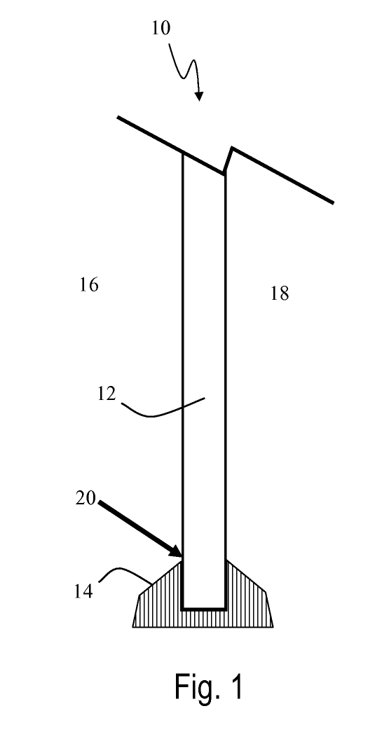

FIG. 1 represents a schematic, partial overhead, cross-sectional view of a conventional vehicle window generally at 10. As shown, a pane of heat strengthened glass 12 is positioned so that at least one of its edges is located in a channel 14. In this example the channel 14 is located at the trailing edge of the glass 12, but other variations are, of course, possible. The inside 16 and the outside 18 of the vehicle are also shown. The point of greatest weakness of the window in FIG. 1 is shown at point 20, which is approximately at end of the channel 14. When a blow is delivered to the outside 16 surface of the glass 12, the glass 12 will tend to break and give way at point 20, resulting in the glass 12 being completely removed from the opening in the vehicle while leaving some residual bits of glass in the channel 14.

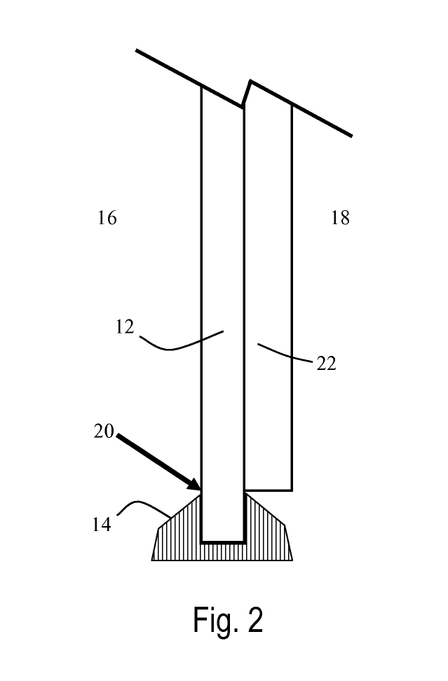

FIG. 2 shows an offset window that adds strength through the addition of an offset pane of glass 22 on the inside 18 of the original pane of glass 12. As will be described in detail, below, the offset pane of glass 22 can be, for example, a relatively thick pane of tempered glass. The “offset” configuration shown in FIG. 2 refers to the recessed edge of the offset pane of glass 22, which does not extend as far as the original pane of glass 18. The purpose of this offset is to allow for an exact, or almost exact, replacement of the standard panel, shown in FIG. 1, with the window shown in FIG. 2, without the need to significantly modify the channel 14 or the door. While the window shown in FIG. 2 is more resistant to the penetration of a bullet than the window shown in FIG. 1, it too suffers from the same inherent weakness; namely, that a blow to the outside 16 surface of the outside glass 12 will tend to cause the breaking and giving way of the glass 12 at point 20, resulting in the dislocation of the window from the window frame.

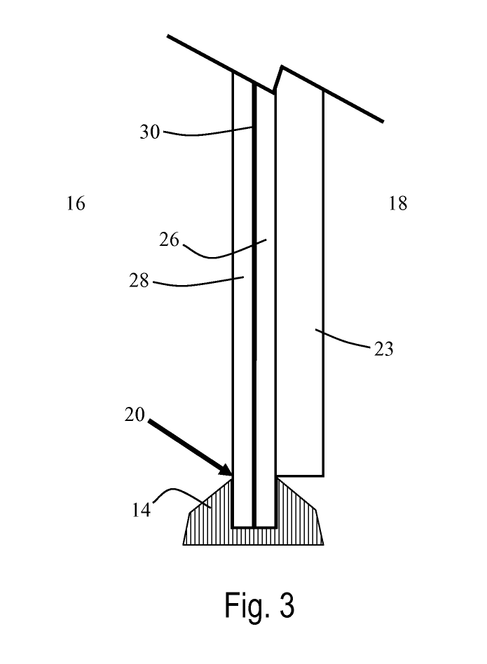

FIG. 3 shows an embodiment of the present invention in which a laminated glass panel (elements 26, 28, and 30) is used in place of the ordinary glass 12 shown in FIG. 2. Laminated glass panels of the present invention can have, for example and without limitation, a total thickness of 1.0 to 6.0 millimeters, or 1.6 to 5.5 millimeters. While the laminated glass panel is shown in FIG. 3 as a three layer construct having a polymer sheet 30 disposed between two panes of glass 26, 28, any suitable laminated glass construct can be used, as will be discussed in more detail, below. An offset glazing panel 23 is adhered to the laminated glass panel. The offset glazing panel can be any suitable glazing, as will be discussed in detail, below. As used herein, a window is an “offset” window or has an “offset” pane or glazing if the edge of one glazing is not even with the corresponding edge of a second glazing to which in is adhered, but rather is shorter. In the embodiment shown in FIG. 3, the offset glazing panel 23 is offset from the laminated glass panel (elements 26, 28, and 30), and the entire construct is an offset window. Similarly, an edge on one glazing is said to be “offset” from the edge on an adjacent, adhered glazing, if the edge on the one glazing is not even with the edge on the adjacent glazing but is instead shorter.

Windows of the present invention can have offsets of, for example and without limitation, 2 to 55 millimeters, 2 to 40 millimeters, or 2 to 20 millimeters.

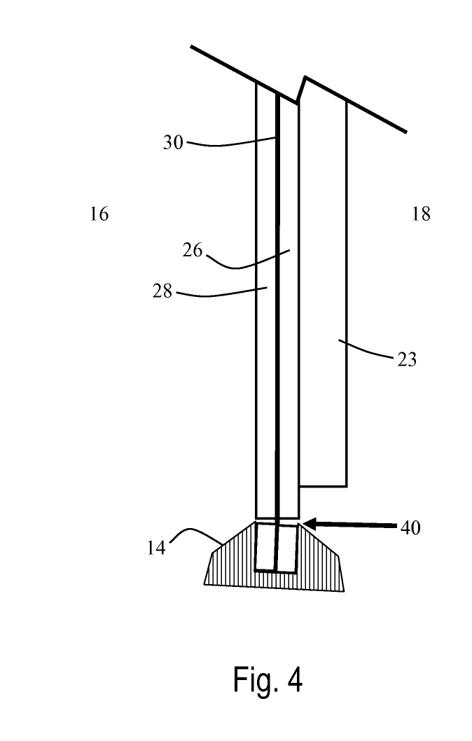

FIG. 4 demonstrates schematically what occurs with a window of the present invention when a severe impact to the outside of the window occurs. In this case, an impact can break the glass panes 26, 28 of the laminated glass panel along the edge of the channel 14, but, unlike conventional glass, the polymer sheet 30 of the laminated glass panel will not be broken by the impact (see 40). The glass and polymer sheet in the channel will tend to stay in place, thereby preventing the pull out of the polymer sheet 30 and the resultant dislocation of the laminated glass panel from the window opening. Windows of the present invention, relative to conventional offset windows, can withstand a greater impact, and more repeated impacts, without dislocating from the window opening, thereby preventing easy entry into the vehicle space, by, for example impacts from a hand-held implement or from projectiles such as stones and other thrown objects.

The offset windows of the present invention can have offset edges on more than one edge. For example, offset windows in a typical automobile application can have offset edges on the leading edge, top edge, and trailing edge. In this design, the laminated glass panel trailing edge will typically move within the channel as the window is opened and closed, while the top and leading edges will engage the channel only in the fully closed position. Other examples will be apparent to those of skill in the art. Windows of the present invention can have offset edges on any portion of the entire edge, as is appropriate for any given application.

In various embodiments of the present invention, an offset window is retractable and has at least one laminated glass panel edge disposed within a channel. In other embodiments, two or more, or all laminated glass panel edges are disposed within a channel.

The laminated glass panel of the present invention can be any suitable laminated glass panel, including, for example, laminated constructions that have any of the polymer layer arrangements shown below between two panes of glass and in place the polymer sheet shown as element 30, where a “polymer sheet” and a “polymer film” will be defined in more detail elsewhere:

(polymer sheet)ₙ(polymer sheet/(polymer film)ₓ/polymer sheet)_{y}

where n can be 1 to 10 and preferably is 1, 2, or 3, where x is 1 to 5, and in preferred embodiments is 1 or 2, and where y is 1 or 2.

In further embodiments, the laminated glass panel can be a bilayer having the following construction: glass/polymer sheet/polymer film, with the glass facing toward either the inside or the outside of the vehicle.

The glass used in the laminated glass panels of the present invention can be any suitable glass, and, in various embodiments, the glass is heat strengthened glass, annealed glass, or tempered glass.

The glazing panel shown as element 23 in the Figures can be any suitable panel, and can be, for example, but not limited to, a tempered glass pane, a polycarbonate layer, a laminated glass panel, or any other equivalently suitable panel. The thickness of the glazing panel will vary with the intended application and the material chosen. Tempered glass glazing panels, for example, can have a thickness of 3.0 to 20 millimeters, or 2.1 to 5.0 millimeters.

The laminated glass panels of the present invention, as will be described below, can be formed using any conventional lamination technique. The glazing panel can be adhered to the laminated glass panel using any suitable method, depending on the glazing panel, including, but not limited to, through spray on or roll on adhesives or by using a pre-formed layer of adhesive material between the glazing panel and the laminated glass panel and laminating the construct using conventional laminating techniques. In the latter embodiments, the pre-formed layer of adhesive material can be any of the polymeric compounds given below for the polymer sheet component of the invention. The layer of adhesive material can be relatively thin, as its function is to adhere the two layers rather than, alone, to provide impact resistance.

### Polymer Sheet

As used herein, a “polymer sheet” means any thermoplastic polymer composition formed by any suitable method into a sheet that provides adequate penetration and glass retention properties to laminated glazing panels. Plasticized poly(vinyl butyral) is most commonly used to form polymer sheets. In various embodiments of the present invention, polymer sheets can be between 0.01 and 4.0 millimeters, 0.1 to 2.0 millimeters, 0.25 to 1.0 millimeters, or 0.3 to 0.7 millimeters in thickness.

The polymer sheets of the present invention can comprise any suitable polymer, and, in a one embodiment the polymer sheet comprises poly(vinyl butyral). In any of the embodiments of the present invention given herein that comprise poly(vinyl butyral) as the polymeric component of the polymer sheet, another embodiment is included in which the polymer component consists of or consists essentially of poly(vinyl butyral). In these embodiments, any of the variations in additives, including plasticizers, disclosed herein can be used with the polymer sheet having a polymer consisting of or consisting essentially of poly(vinyl butyral).

In one embodiment, the polymer sheet comprises a polymer based on partially acetalized poly(vinyl alcohol)s. In further embodiments the polymer sheet comprises poly(vinyl butyral) and one or more other polymers. In any of the sections herein in which preferred ranges, values, and/or methods are given specifically for poly(vinyl butyral) (for example, and without limitation, for plasticizers, component percentages, thicknesses, and characteristic-enhancing additives), those ranges also apply, where applicable, to the other polymers and polymer blends disclosed herein as useful as components in polymer sheets.

For embodiments comprising poly(vinyl butyral), the poly(vinyl butyral) can be produced by any suitable method. Details of suitable processes for making poly(vinyl butyral) are known to those skilled in the art (see, for example, U.S. Pat. Nos. 2,282,057 and 2,282,026). In one embodiment, the solvent method described in Vinyl Acetal Polymers, in Encyclopedia of Polymer Science & Technology, 3^{rd} edition, Volume 8, pages 381-399, by B. E. Wade (2003) can be used. In another embodiment, the aqueous method described therein can be used. Poly(vinyl butyral) is commercially available in various forms from, for example, Solutia Inc., St. Louis, Mo. as Butvar™ resin.)

In various embodiments, the resin used to form polymer sheet comprising poly(vinyl butyral) comprises 10 to 35 weight percent (wt. %) hydroxyl groups calculated as poly(vinyl alcohol), 13 to 30 wt. % hydroxyl groups calculated as poly(vinyl alcohol), or 15 to 22 wt. % hydroxyl groups calculated as poly(vinyl alcohol). The resin can also comprise less than 15 wt. % residual ester groups, 13 wt. %, 11 wt. %, 9 wt. %, 7 wt. %, 5 wt. %, or less than 3 wt. % residual ester groups calculated as polyvinyl acetate, with the balance being an acetal, preferably butyraldehyde acetal, but optionally including other acetal groups in a minor amount, e.g., a 2-ethyl hexanal group (see, for example, U.S. Pat. No. 5,137,954).

In various embodiments, the polymer sheet comprises poly(vinyl butyral) having a molecular weight of at least 30,000, 40,000, 50,000, 55,000, 60,000, 65,000, 70,000, 120,000, 250,000, or at least 350,000 grams per mole (g/mole or Daltons). Small quantities of a dialdehyde or trialdehyde can also be added during the acetalization step to increase molecular weight to at least 350,000 g/m (see, for example, U.S. Pat. Nos. 4,902,464; 4,874,814; 4,814,529; 4,654,179). As used herein, the term “molecular weight” means the weight average molecular weight.

Various adhesion control agents can be used in polymer sheets of the present invention, including sodium acetate, potassium acetate, and magnesium salts. Magnesium salts that can be used with these embodiments of the present invention include, but are not limited to, those disclosed in U.S. Pat. No. 5,728,472, such as magnesium salicylate, magnesium nicotinate, magnesium di-(2-aminobenzoate), magnesium di-(3-hydroxy-2-napthoate), and magnesium bis(2-ethyl butyrate) (chemical abstracts number 79992-76-0). In various embodiments of the present invention the magnesium salt is magnesium bis(2-ethyl butyrate).

Additives may be incorporated into the polymer sheet to enhance its performance in a final product. Such additives include, but are not limited to, the following agents: antiblocking agents, plasticizers, dyes, pigments, stabilizers (e.g., ultraviolet stabilizers), antioxidants, flame retardants, IR absorbers, and combinations of the foregoing additives, and the like, as are known in the art.

In various embodiments of polymer sheets of the present invention, the polymer sheets can comprise 5 to 60, 25 to 60, 5 to 80, or 10 to 70 parts plasticizer per one hundred parts of resin (phr). Of course other quantities can be used as is appropriate for the particular application. In some embodiments, the plasticizer has a hydrocarbon segment of fewer than 20, fewer than 15, fewer than 12, or fewer than 10 carbon atoms.

The amount of plasticizer can be adjusted to affect the glass transition temperature (T_{g}) of the poly(vinyl butyral) sheet. In general, higher amounts of plasticizer are added to decrease the T_{g}. Poly(vinyl butyral) polymer sheets of the present invention can have a T_{g} of, for example, 40° C. or less, 35° C. or less, 30° C. or less, 25° C. or less, 20° C. or less, and 15° C. or less.

Any suitable plasticizers can be added to the polymer resins of the present invention in order to form the polymer sheets. Plasticizers used in the polymer sheets of the present invention can include esters of a polybasic acid or a polyhydric alcohol, among others. Suitable plasticizers include, for example, triethylene glycol di-(2-ethylbutyrate), triethylene glycol di-(2-ethylhexanoate), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, polymeric plasticizers such as the oil-modified sebacic alkyds, and mixtures of phosphates and adipates such as disclosed in U.S. Pat. No. 3,841,890 and adipates such as disclosed in U.S. Pat. No. 4,144,217, and mixtures and combinations of the foregoing. Other plasticizers that can be used are mixed adipates made from C₄ to C₉ alkyl alcohols and cyclo C₄ to C₁₀ alcohols, as disclosed in U.S. Pat. No. 5,013,779 and C₆ to C₈ adipate esters, such as hexyl adipate. In various embodiments, the plasticizer used is dihexyl adipate and/or triethylene glycol di-2 ethylhexanoate.

In various other embodiments of the present invention, polymer sheets comprise a polymer selected from the group consisting of poly(vinyl butyral), polyurethane, polyvinyl chloride, poly(ethylene-co-vinyl acetate), polyethylene, polyethylene copolymers, partially neutralized ethylene/(meth)acrylic copolymers, poly(cyclohexanedimethylene terephthalate-co-ethylene terephthalate) copolyester, combinations thereof, and the like.

Various embodiments include poly(ethylene-co-vinyl acetate) as describe in U.S. Pat. No. 4,614,781, U.S. Pat. No. 5,415,909, U.S. Pat. No. 5,352,530, and U.S. Pat. No. 4,935,470. Various embodiments include polyurethane comprising, for example, aliphatic isocyanate polyether based polyurethane (available from Thermedics Polymer Products of Noveon Inc.). Other additives can be incorporated into the polyurethane resins during extrusion, such as UV stabilizers and functional chemicals to provide high adhesion to glass.

Polymeric resins can be thermally processed and configured into sheet form according to methods known to those of ordinary skill in the art. As used herein, “resin” refers to the polymeric (for example poly(vinyl butyral) or poly(vinyl chloride)) component of a polymer composition. Resin will generally have other components in addition to the polymer, for example, components remaining from the polymerization process. As used herein, “melt” refers to a melted mixture of resin with a plasticizer, if required, and optionally other additives, for example, performance enhancing agents.

One exemplary method of forming a poly(vinyl butyral) sheet comprises extruding molten poly(vinyl butyral) comprising resin, plasticizer, and additives—the melt—by forcing the melt through a sheet die (for example, a die having an opening that is substantially greater in one dimension than in a perpendicular dimension). Another exemplary method of forming a poly(vinyl butyral) sheet comprises casting a melt from a die onto a roller, solidifying the resin, and subsequently removing the solidified resin as a sheet.

Polymer sheets of the present invention also include polymer sheets that are formed through coextrusion processes, whereby dissimilar polymer melts are coextruded to form a single sheet, as is known in the art.

In order to impart even greater intrusion resistance to the windows of the present invention, one or more of the polymer sheet layers used in the window can have a relatively high glass transition temperature of about 35° C. or greater such as those disclosed in published U.S. Patent Application US20050170160.

### Polymer Film

As used herein, a “polymer film” means a relatively thin and rigid polymer layer that functions as a performance enhancing layer. Polymer films differ from polymer sheets, as used herein, in that polymer films do not themselves provide the necessary impact resistance and glass retention properties to a multiple layer glazing structure, but rather provide performance improvements, such as infrared absorption character. Poly(ethylene terephthalate) is most commonly used as a polymer film.

Polymer films used in the present invention can be any suitable film that is sufficiently rigid to provide a relatively flat, stable surface, for example those polymer films conventionally used as a performance enhancing layer in multiple layer glass panels. The polymer film is preferably optically transparent (i.e. objects adjacent one side of the layer can be comfortably seen by the eye of a particular observer looking through the layer from the other side), and usually has a greater, in some embodiments significantly greater, tensile modulus regardless of composition than that of the adjacent polymer sheet. In various embodiments, the polymer film comprises a thermoplastic material. Among thermoplastic materials having suitable properties are nylons, polyurethanes, acrylics, polycarbonates, polyolefins such as polypropylene, cellulose acetates and triacetates, vinyl chloride polymers and copolymers and the like. In various embodiments, the polymer film comprises materials such as re-stretched thermoplastic films having the noted properties, which include polyesters. In various embodiments, the polymer film comprises or consists of poly(ethylene terephthalate), and, in various embodiments, the poly(ethylene terephthalate) has been biaxially stretched to improve strength, and/or has been heat stabilized to provide low shrinkage characteristics when subjected to elevated temperatures (e.g. less than 2% shrinkage in both directions after 30 minutes at 150° C.).

In various embodiments, the polymer film can have a thickness of 0.013 millimeters to 0.25 millimeters, 0.025 millimeters to 0.1 millimeters, or 0.04 to 0.06 millimeters. The polymer film can optionally be surface treated or coated with a functional performance layer to improve one or more properties, such as adhesion or infrared radiation reflection. These functional performance layers include, for example, a multi-layer stack for reflecting infra-red solar radiation and transmitting visible light when exposed to sunlight. This multi-layer stack is known in the art (see, for example, WO 88/01230 and U.S. Pat. No. 4,799,745) and can comprise, for example, one or more Angstroms-thick metal layers and one or more (for example two) sequentially deposited, optically cooperating dielectric layers. As is also known (see, for example, U.S. Pat. Nos. 4,017,661 and 4,786,783), the metal layer(s) may optionally be electrically resistance heated for defrosting or defogging of any associated glass layers. Various coating and surface treatment techniques for poly(ethylene terephthalate) film and other polymer films that can be used with the present invention are disclosed in published European Application No. 0157030. Polymer films of the present invention can also include a hardcoat and/or and antifog layer, as are known in the art.

In various embodiments of the present invention, two or more polymer films are bonded together with adhesive to form a composite polymer film that adds to the overall penetration resistance of an offset window of the present invention when included in a laminated glass panel either between two layers of glass or in a bilayer construction. In these embodiments, the individual layers of polymer films are each preferably poly(ethylene terephthalate) that are 0.175 millimeters thick or less and are bonded with an adhesive that has a negligible thickness, for example less than 0.01 millimeters. Such composite polymer film layers are taught in published U.S. Patent Application US20050106372.

In various embodiments of the present invention, a polymer film layers such as poly(ethylene terephthalate) can be directly printed with dyes, inks, pigments, and the like to impart a pattern or other optical effect upon the finished product.

The present invention includes vehicles comprising an offset window of the present invention.

The present invention includes vehicle window frames comprising an offset window of the present invention, as well all vehicle body panels, such as doors, comprising an offset window of the present invention.

The present invention includes methods of securing the interior space of a vehicle, comprising placing in an opening in the vehicle a window of the present invention.

In addition to the embodiments given above, other embodiments comprise a rigid glazing substrate other than glass in the laminated glass panel. In these embodiments, the rigid substrate can comprise acrylic such as Plexiglass®, polycarbonate such as Lexan®, and other plastics, that are conventionally used as glazings.

Various polymer sheet and/or laminated glass characteristics and measuring techniques will now be described for use with the present invention.

The clarity of a polymer sheet, can be determined by measuring the haze value, which is a quantification of the scattered light by a sample in contrast to the incident light. The percent haze can be measured according to the following technique. An apparatus for measuring the amount of haze, a Hazemeter, Model D25, which is available from Hunter Associates (Reston, Va.), can be used in accordance with ASTM D11003-61 (Re-approved 1977)-Procedure A, using Illuminant C, at an observer angle of 2 degrees. In various embodiments of the present invention, percent haze is less than 5%, less than 3%, and less than 1%.

Pummel adhesion can be measured according to the following technique, and where “pummel” is referred to herein to quantify adhesion of a polymer sheet to glass, the following technique is used to determine pummel. Two-ply glass laminate samples are prepared with standard autoclave lamination conditions. The laminates are cooled to about −17.8° C. (0° F.) and manually pummeled with a hammer to break the glass. All broken glass that is not adhered to the polymer sheet is then removed, and the amount of glass left adhered to the polymer sheet is visually compared with a set of standards. The standards correspond to a scale in which varying degrees of glass remain adhered to the poly(vinyl butyral) sheet. In particular, at a pummel standard of zero, no glass is left adhered to the polymer sheet. At a pummel standard of 10, 100% of the glass remains adhered to the polymer sheet. For laminated glass panels of the present invention, various embodiments have a pummel of at least 3, at least 5, at least 8, at least 9, or 10. Other embodiments have a pummel between 8 and 10, inclusive.

The “yellowness index” of a polymer sheet can be measured according to the following: transparent molded disks of polymer sheet 1 cm thick, having smooth polymeric surfaces which are essentially plane and parallel, are formed. The index is measured according to ASTM method D 1925, “Standard Test Method for Yellowness Index of Plastics” from spectrophotometric light transmittance in the visible spectrum. Values are corrected to 1 cm thickness using measured specimen thickness. In various embodiments of the present invention, a polymer sheet can have a yellowness index of 12 or less, 10 or less, or 8 or less.

By virtue of the present invention, improved impact resistance vehicle windows are provided that function to retain.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout. For example, a polymer sheet can be formed comprising plasticizer in any of the ranges given in addition to any of the ranges given for an adhesion control agent, to form many permutations that are within the scope of the present invention.

Figures are understood to not be drawn to scale unless indicated otherwise.

Each reference, including journal articles, patents, applications, and books, referred to herein is hereby incorporated by reference in its entirety.

We claim:

1. A vehicle window, comprising:
a laminated glass panel having a laminated glass panel edge; and,
a glazing panel adhered to said laminated glass panel having a glazing panel edge, wherein said glazing panel edge is offset from said laminated glass panel edge by at least 2 millimeters.

2. The window of claim 1, wherein said laminated glass panel comprises a polymer sheet disposed between two layers of glass.

3. The window of claim 2, wherein said polymer sheet comprises a polymer selected from the group consisting of poly(vinyl butyral), polyurethane, polyvinyl chloride, poly(ethylene-co-vinyl acetate), polyethylene, polyethylene copolymers, partially neutralized ethylene/(meth)acrylic copolymers, and poly(cyclohexanedimethylene terephthalate-co-ethylene terephthalate) copolyester.

4. The window of claim 3, wherein said polymer sheet comprises poly(vinyl butyral).

5. The window of claim 1, wherein said laminated glass panel has a thickness of 3 to 6 millimeters.

6. The window of claim 1, wherein said laminated glass panel comprises heat strengthened glass.

7. The window of claim 1, wherein said laminated glass panel comprises two panes of tempered or semi-tempered glass.

8. The window of claim 1, wherein said glazing panel is a pane of tempered glass.

9. The window of claim 8, wherein said tempered glass has a thickness of 1.6 to 5.5 millimeters.

10. The window of claim 1, wherein said glazing panel and said laminated glass panel are adhered with poly(vinyl butyral), polyurethane, polyvinyl chloride, poly(ethylene-co-vinyl acetate), polyethylene, polyethylene copolymers, partially neutralized ethylene/(meth)acrylic copolymers, and poly(cyclohexanedimethylene terephthalate-co-ethylene terephthalate) copolyester.

11. A method of securing a vehicle, comprising placing in an opening of said vehicle a vehicle window, comprising:
a laminated glass panel having a laminated glass panel edge; and,
a glazing panel adhered to said laminated glass panel having a glazing panel edge, wherein said glazing panel edge is offset from said laminated glass panel edge by at least 2 millimeters.

12. The method of claim 11, wherein said laminated glass panel comprises a polymer sheet disposed between two layers of glass.

13. The method of claim 12, wherein said polymer sheet comprises a polymer selected from the group consisting of poly(vinyl butyral), polyurethane, polyvinyl chloride, poly(ethylene-co-vinyl acetate), polyethylene, polyethylene copolymers, partially neutralized ethylene/(meth)acrylic copolymers, and poly(cyclohexanedimethylene terephthalate-co-ethylene terephthalate) copolyester.

14. The method of claim 13, wherein said polymer sheet comprises poly(vinyl butyral).

15. The method of claim 11, wherein said laminated glass panel has a thickness of 3 to 6 millimeters.

16. The method of claim 11, wherein said laminated glass panel comprises heat strengthened glass.

17. The method of claim 11, wherein said laminated glass panel comprises two panes of tempered or semi-tempered glass.

18. The method of claim 11, wherein said glazing panel is a pane of tempered glass.

19. The method of claim 18, wherein said tempered glass has a thickness of 1.6 to 5.5 millimeters.

20. The method of claim 11, wherein said glazing panel and said laminated glass panel are adhered with poly(vinyl butyral), polyurethane, polyvinyl chloride, poly(ethylene-co-vinyl acetate), polyethylene, polyethylene copolymers, partially neutralized ethylene/(meth)acrylic copolymers, and poly(cyclohexanedimethylene terephthalate-co-ethylene terephthalate) copolyester.
